(19) United States
(12) Patent Application Publication
(10) Pub. No.: US 2002/0032904 A1
(43) Pub. Date: Mar. 14, 2002

(54) Interactive system and method for collecting data and generating reports regarding viewer habits

(76) Inventor: David S. Lerner, Boca Raton, FL (US)

Correspondence Address: VAN DYKE & ASSOCIATES, P.A., 1630 HILLCREST STREET, ORLANDO, FL, 32803, US

(21) Appl. No.: 09/865,319

(22) Filed: May 25, 2001

Related U.S. Application Data
(60) Provisional application No. 60/206,648, filed on May 24, 2000.

(51) Int. Cl. H04N 7/173; H04N 7/16

(52) U.S. Cl. 725/14; 725/134; 725/110

(57) ABSTRACT

The present invention relates to a system and method for collecting and transmitting data concerning the viewing habits of a viewer. The present invention instantaneously records the data concerning the viewing habits of the viewer while he or she watches programming on a television or streaming media on a conventional personal computer (PC) monitor.

Cross Reference to Related Applications

This is a regular non-provisional application which claims priority to provisional application Serial No.60/206,648, filed May 24, 2000.

### FIELD OF THE INVENTION

The present invention relates to a system and method for collecting and transmitting data concerning the viewing habits of a viewer. The present invention instantaneously records the data concerning the viewing habits of the viewer while he or she watches programming on a television or streaming media on a conventional personal computer (PC) monitor.

### BACKGROUND INFORMATION

Network, cable and independent television stations broadcast programs to viewers via conventional airwaves transmission, satellite transmission and cable TV systems. The television stations develop and broadcast programs based upon viewer interest and availability of advertising sponsorship. Advertisers purchase advertising time slots, e.g., commercials, during the broadcast program in order to market goods and/or services to the viewing audience. The television stations generally determine rates for the commercials based upon the number of viewers as determined through a media research agency such as Nielsen Media Research. The media research agency estimates the number viewers per broadcast based upon an small electronic sampling system. The current sampling system in operation places electronic meters in five thousand randomly selected households which comprises one sample and typically five samples are taken per day. The electronic meters currently in use collect data regarding which-channels the viewers are watching and may provide some information as to who is watching. The data collected on the electronic meters is automatically transmitted to a central database. In addition to the use of an electronic meter, the viewer may also have to complete a handwritten viewing log which catalogues which broadcasts they actually watched. Also, individuals may have to train the households on the use of the electronic meter and how to correctly complete any viewing logs.

Although, the present ratings system provides an estimate of the actual viewing audience, the resulting ratings are based on a relatively small sample when compared to the total viewing audience, e.g., 5000 households per sample v. 99.4 million TV households in the U.S. The present ratings system must therefore extrapolate and estimate the viewing habits of the households based on significantly small number of households. The present invention provides a system and method that allows the collection of data regarding viewing habits from a larger sample in a more efficient and accurate manner. The present invention eliminates the necessity for any training of the household regarding its use and allows the actual viewer to maintain greater anonymity and not sacrifice accuracy. Also, the present invention eliminates the need for the viewer to maintain a handwritten log.

### SUMMARY OF THE INVENTION

The present invention relates to a system and method for collecting and transmitting data concerning the viewing habits of a viewer. The present invention instantaneously records the data concerning the viewing habits of the viewer while he or she watches programming on a television or streaming media on a conventional personal computer (PC) monitor. The data concerning the viewer's viewing habits is collected and stored onto a memory arrangement, e.g., memory chip, memory card or flash memory chip, within a universal remote control if the viewer is watching television programming or the data may be stored on the memory residing within the PC if the viewer is watching streaming media on a PC monitor. The viewer periodically transmits this data to a server arrangement via a communications network. The server arrangement compiles and generates general statistical reports concerning the viewer's viewing habits. The server arrangement generates reports which are then available to interested parties such as network and cable broadcasters, syndicators, advertisers, local television broadcasters, local cable companies, satellite distributors, owners of the system itself, advertising agencies, program producers, news media, research analysts and any other interested individuals and organizations.

### BRIEF DESCRIPTION OF THE DRAWINGS

FIG. 1 shows an exemplary embodiment of the present invention.

FIG. 2 shows a second exemplary embodiment of the present invention.

### DETAILED DESCRIPTION

The present invention includes a universal infrared remote control equipped with memory capabilities such as a memory card or chip. The viewer may use the remote control while watching a television broadcast. In one exemplary embodiment, the remote control records and stores the channels that the viewer views during a sitting. The viewer inputs a unique user code in order to identify himself or herself as the actual user, the remote control records the unique user code and channels viewed by the viewer while operating the remote control. The remote control also records the length of time each channel was viewed by the viewer based upon a minimum amount of viewing time. When a new viewer desires to operate the remote control he or she inputs a unique user code and the remote control again records and stores the viewer's actions associated with the current viewer. A channel code is associated with each channel so that the remote control records both the user and channel code. The viewers submit demographic data, e.g. age, sex, race, marital status and geographic location, to the server arrangement at the time the viewer starts using the system. So, when the viewer transmits his or her viewing data using the unique user code, the server arrangement has the appropriate demographic information associated with it. The viewer may update any associated demographic data stored on the server arrangement at any time. When a viewer transmits his or her demographic information, an identification verification method may be employed such as through the use of credit card accounts or a viewer registration form accessible from the server arrangement. The verification method assists in ensuring the accuracy of the viewer data. Although, the above embodiment describes a single viewer, the present invention may include a plurality of viewers, a plurality of server arrangements, and a plurality of user computing arrangements.

Once the viewer has completed his or her viewing for a certain time period, the viewer may then transmit the stored data to the server arrangement via a communications network. The time period between the transmittal of stored data may vary depending upon the storage capabilities of the storage arrangement within the remote control. In one exemplary embodiment, the stored data may be transmitted to a server arrangement by connecting the remote to a user computing arrangement, e.g., a personal computer, where the user computing arrangement establishes a connection to the server arrangement via the communications network. Other methods of transmitting the stored data to the server arrangement may include the use of removable memory cards within the remote control, transfer of the stored data onto a separate storage arrangement, e.g. floppy disk, CD-ROM, DVD, etc., transfer of data through the use of wireless technology, e.g. cellular phones, satellite connections, PDA's, use of a docking station connected to a USB port of a user computing arrangement or transfer directly to an infrared receiver connected to a user computing arrangement. Upon receipt of the data, the server arrangement stores the data and may generate statistical reports based upon the data it receives from the viewers. Software residing in the memory arrangement of the universal remote control formats the stored data for transmittal to the server arrangement. The software provides the functionality for the storage and transmittal of data.

In one exemplary embodiment, the server arrangement may generate statistical data on the number of viewers viewing any channel on any given day at any particular time. If a business user, e.g., a broadcast producer, network executive, advertiser, etc., wants to know how many viewers watched a particular broadcast, then he or she may connect to the server arrangement via the communications network. The business user may submit a query to the server arrangement and the server arrangement transmits a report to the business user's computing arrangement that contains the requested data. The reports available to the business users may contain a plethora of data concerning viewing habits such as ranking of the most popular broadcasts, the most watched time slots, what age groups are watching, what type of broadcast programs are watched by certain age groups, ranking of broadcast programs by region of the country, etc. Also, the general information concerning viewer habits may be accessible at an interactive webpage maintained by the server arrangement. In one exemplary embodiment, the interactive webpage would include a continuous stream of data concerning the real time rating results similar to real time stock quotes. Viewers who access the interactive webpage are able to make additional comments concerning recent broadcast programs. Also, broadcasters and advertisers may post opinion polls and receive feedback concerning their broadcast programs through the interactive webpage.

In yet another exemplary embodiment, the present invention may be used in conjunction with a conventional personal computer (PC) in order to create ratings for broadband broadcasts over the World Wide Web, e.g., Broadcast.com. Similar to the above use with a universal remote control, the present invention may also be used to collect and store data concerning streaming media that a viewer may watch on a conventional personal computer (PC) monitor. The data concerning the streaming media viewing may be stored on the memory arrangement residing on the PC, e.g., the hard drive storage, or the data may be stored on a portable storage arrangement, e.g., a floppy disk drive or CD ROM. Also, software residing on the PC's storage arrangement enables the storage and transmittal of the data to a server arrangement. The user may obtain the software by retrieving a copy from the server arrangement or transferring the software from a portable storage arrangement onto the memory residing within the PC. When used in this manner, the present invention could store a viewer's viewing and listening habits while viewing streaming media, e.g., conventional and INTERNET radio broadcasts, conventional and INTERNET television broadcasts, short films, movies, audio files (MP3, INTERNET jukeboxes), sports events, video files, publications, etc. over the World Wide Web. The present invention could record the location, e.g., URL address, visited by the user and the time the user spends viewing the streaming media and store the data on the memory residing within the PC, a floppy disk or CD ROM. As described above with the universal remote control, once the viewer completes his or her viewing of streaming media, the viewer may periodically transmit the stored data to a server arrangement via a communications network. The server arrangement then generates statistical reports based upon the data it receives as described above.

The present invention provides a universal remote control device capable of storing data regarding the viewer's viewing habits and transmitting the stored data to a sever arrangement via a communications network. It also provides a means to store and transmit data to the server arrangement regarding viewing habits related to streaming media over the World Wide Web. Business users may then retrieve reports generated by the server arrangement containing statistical data regarding the viewing habits of the viewers who use the present invention. In addition to customized reports for business users, the server arrangement may generate general information regarding the viewer habits. The general information may be readily accessible to the general public through conventional communication network systems such as the INTERNET on the interactive webpage described above. The general public may access the general information from an interactive webpage maintained through the use of the server arrangement. Also, the server arrangement may transmit the general information via a communication network such as the INTERNET to any accessible location, e.g. webpage on the World Wide Web, such as Yahoo, Excite, AOL, About, Netscape, Lycos, MSN or Go. Therefore, the present invention provides specialized information for business users and general information for the public, all of which concerns the viewing habits of a much larger, diverse and dynamic sample audience. Although, the present invention is described in the context of the television, it is also conducive to any media format, e.g., films, movies, music, electronic publications, where the user views or listens to various content from multiple sources such as radio broadcasts where the listener may listen to various radio broadcast stations, viewing various webpages over the World Wide Web, changing music selections from a predetermined database, e.g., MP3, music transferred through real time streaming, music accessible for content sharing or electronic publications, e.g. books, magazines, newspapers, that may be accessible from various locations.

It will further be noted by those skilled in the art that the remote of the present invention may interact with known systems such as the TEVO or REPLAY systems. For example the Phillips TiVo HDR312 and TiVo HDR612 systems provide up to 30 hours of storage capacity, 8-second instant replay of content, pause, fast forward, rewind and jump-to-live buttons on remotes with multiple picture quality settings. ReplayTV has created the foundation for offering personal television to viewers worldwide via digital set-top boxes. ReplayTV gives viewers the ability to find and record their favorite shows so they can be watched at any time. ReplayTV also controls live television with pause, rewind, instant replay and slow-motion features. The remote of the present invention is adapted and adaptable for use in connection with such digital video recorder devices and provides information with respect to channels and content that is recorded and most preferred by viewers using such devices.

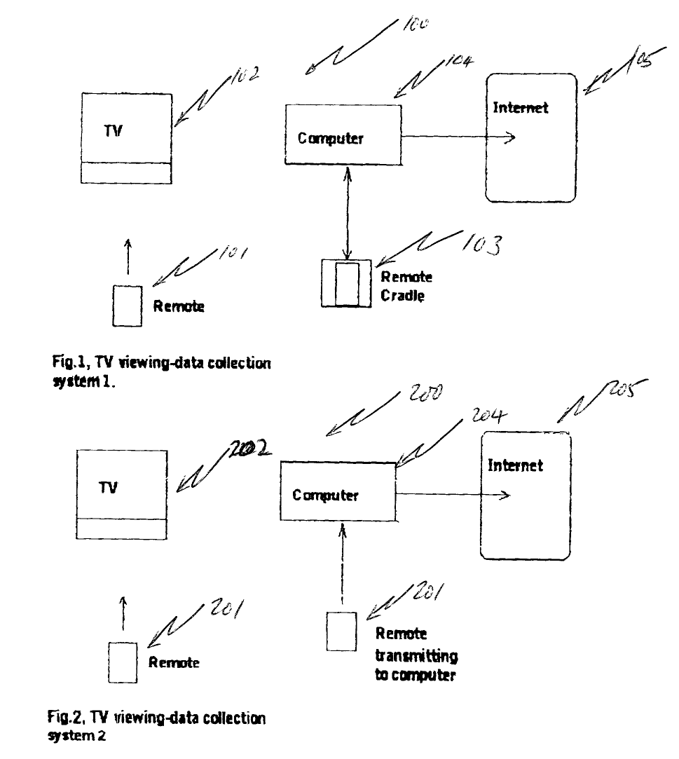

With specific reference to the figures, which are provided to further exemplify this invention, without limiting the invention to the specifics thereof, in FIG. 1, there is shown a first embodiment 100 of the interactive system of this invention. In this system, the viewer uses a remote 101 to control a television or computer 102. Where a computer is employed in this system, as in the viewing of streaming media, “surfing” the world wide web, visiting various universal resource locator addresses, or the like, the use of a remote may not be critical, although tracking of the browsing and surfing information and period spent at a given location on the world wide web may be tracked by a remote unit according to this invention. The remote 101 contains software and hardware known in the art to track stations as the user selects different channels. Each button depressed is recorded into the memory of the remote 101 for subsequent or simultaneous transmission of the viewing data to a server system. The data may be directly transmitted by the remote 101, or the data may be downloaded to a cradle 103 for transmission to a computer 104 for analysis of the data. The computer 104 may transmit the data or analysis thereof to remote locations via the distributed global computer network, i.e. the INTERNET 105 or via discrete private linkups over telephone lines, wide area networks, local area networks or the like. The remote 101 may be rechargeable, and the cradle 103 may be adapted to recharge the remote. The data may be downloaded to the cradle 103 for transmission to a computer 104, or the cradle may signal the remote 101 to transmit the data to a computer 104 via an infra-red receiver linked to the computer, or via a wired connection. The receiving computer 104 preferably processes the data into a defined format for direct review and/or transmits either the raw data, the processed data, or both to a remote viewing data collection host computer where the information may be further processed and analyzed as needed. The remote 101, while in the cradle 103 may further function as a viewer feedback unit, allowing interactive TV viewing.

With reference to FIG. 2, there is shown a second embodiment 200 of the interactive system of this invention. In this system, the viewer uses a remote 201 to control a television 202. The remote 201 contains software and hardware known in the art to track stations as the user selects different channels. Each button depressed is recorded into the memory of the remote 201 for subsequent or simultaneous transmission of the viewing data to a server system. The data may be directly and automatically transmitted by the remote 201 to a computer 204 via an IR receiver, or the viewer may activate the transmission of the data to the computer 204. The computer 204 may transmit the data or analysis thereof to remote locations via the distributed global computer network, i.e. the INTERNET 205 or via discrete private linkups over telephone lines, wide area networks, local area networks or the like. The remote 201 may be rechargeable, but no cradle need be used in this embodiment of the invention. The receiving computer 204 preferably processes the data into a defined format for direct review and/or transmits either the raw data, the processed data, or both to a remote viewing data collection host computer where the information may be further processed and analyzed as needed.

Having generally and specifically described and disclosed this invention, including its best mode, reference is now made the claims appended hereto, which define the scope of the invention disclosed herein.

What is claimed is:

1. A method for collecting and storing data regarding the viewing habits of a user comprising the steps of:
(a) storing user selections on a memory device;
(b) transmitting user selections stored on the memory device over a network for storage on a further memory device; and
(c) creating a statistical data base based upon the user selections.

2. The method according to claim 1 wherein said memory device is a television, a computer monitor, or a controller for a television or a computer.

3. The method according to claim 2 wherein said controller is a remote controller.

4. The method according to claim 3 wherein said controller is placed into a cradle which optionally charges said controller, and which downloads stored information for simultaneous or subsequent transmission to a collector of said information.

5. The method according to claim 1 wherein said data regarding said viewing habits is specific to a given viewer or location of viewing.

6. The method according to claim 1 wherein said data regarding said viewing habits is specific to the viewing habits of a viewer or group of viewers of television program content.

7. The method according to claim 1 wherein said data regarding said viewing habits is specific to the viewing habits of a viewer or group of viewers of content on the INTERNET.

8. A television, computer or remote controller of a television, computer comprising hardware and software for accurately measuring the time period and providing an indication of the content of the material viewed.

9. An interactive system comprising a remote 101 to control a television or computer 102 which contains software and hardware known to track stations or URL's as the user selects different channels or sites on the world wide web, such that the location and time spent at each location or channel is recorded for subsequent or simultaneous transmission of the viewing data to a server system.

10. The system according to claim 9 wherein said data is directly transmitted by the remote 101, or wherein said data is downloaded to a cradle 103 for transmission to a computer 104 for analysis of the data.

11. The system according to claim 10 wherein said computer 104 transmits the data or analysis thereof to remote locations via the distributed global computer network, the INTERNET 105 or via discrete private linkups over telephone lines, wide area networks, local area networks or combinations thereof.

12. The system according to claim 11 wherein the remote 101 is rechargeable, and the cradle 103 is adapted to recharge the remote.

13. The system according to claim 11 wherein said data is downloaded to the cradle 103 for transmission to a computer 104, or wherein the cradle signals the remote 101 to transmit the data to a computer 104 via an infrared receiver linked to the computer, or via a wired connection.

14. The system according to claim 12 wherein the receiving computer 104 processes the data into a defined format for direct review and/or transmits either the raw data, the processed data, or both to a remote viewing data collection host computer where the information may be further processed and analyzed as needed.

15. The interactive system according to claim 9 comprising a memory which as each button is depressed on a remote 201 is recorded into the memory of the remote 201 for subsequent or simultaneous transmission of the viewing data to a server system, wherein said data is directly and automatically transmitted by the remote 201 to a computer 204 via an IR receiver, or wherein the viewer activates the transmission of the data to the computer 204.

16. The interactive system according to claim 15 wherein the computer 204 transmits the data or analysis thereof to remote locations via the distributed global computer network, i.e. the INTERNET 205 or via discrete private linkups over telephone lines, wide area networks, local area networks or combinations thereof.

17. The system according to claim 16 wherein the receiving computer 204 processes the data into a defined format for direct review and/or transmits either the raw data, the processed data, or both to a remote viewing data collection host computer where the information may be further processed and analyzed as needed.

18. A remote controller for a television or a computer which comprises hardware and software for recording channels or URLs and periods of time during which a viewer of the television or computer views content at said channel or URL and wherein said remote is adapted for transmission of the recorded data to a computer system for analysis of said viewer data.

19. The remote according to claim 18 adapted for use in connection with a digital video recorder.
